(19) United States
(12) Patent Application Publication
(10) Pub. No.: US 2012/0210349 A1
(43) Pub. Date: Aug. 16, 2012

(54) MULTIPLE-SCREEN INTERACTIVE SCREEN ARCHITECTURE

(76) Inventors: David Anthony Campana, Princeton, NJ (US); Shemimon Anthru, Dayton, NJ (US); Ishan Uday Mandrekar, Monmouth Junction, NJ (US); Jens Cahnbley, West Windsor, NJ (US); Saurabh Mathur, Monmouth Junction, NJ (US); David Brian Anderson, Florence, NJ (US)

(21) Appl. No.: 13/504,160

(22) PCT Filed: Oct. 29, 2009
(86) PCT No.: PCT/US09/05918

§ 371 Date: Apr. 26, 2012

(51) Int. Cl. H04N 21/60; H04N 21/482; H04N 21/262; H04N 21/436; H04N 21/61; H04N 21/80

(52) U.S. Cl. 725/32; 725/78; 725/85; 725/82; 725/80; 725/43

(57) ABSTRACT

A method and system are provided for supporting multiple-screen interactivity between at least a first screen on a first device and a second screen on a second device. The system includes an interactivity server for providing complementary content for display on the second screen relative to primary content displayed on the first screen. The system further includes a communication device for communicating the complementary content to the second device to display on the second screen thereof.

### TECHNICAL FIELD

The present principles relate generally to viewing devices and, more particularly, to a multiple-screen interactive screen architecture.

### BACKGROUND

Most media consumption operations are performed with only one device. For example, a user watching a television program typically will view other television programs on the same viewing device (i.e., the same television). Prior art techniques involving two screens are limited to solutions were the two screens are disposed on the same device (such as, for example, a picture-in-picture (PIP) or picture-out-of-picture (POP).

### SUMMARY

These and other drawbacks and disadvantages of the prior art are addressed by the present principles, which are directed to a multiple-screen interactive screen architecture.

According to an aspect of the present principles, there is provided a system for supporting multiple-screen interactivity between at least a first screen on a first device and a second screen on a second device. The system includes an interactivity server for providing complementary content for display on the second screen relative to primary content displayed on the first screen. The system further includes a communication device (e.g., a set top box, a gateway, etc.) for communicating the complementary content to the second device to display on the second screen thereof.

According to another aspect of the present principles, there is provided a method for supporting multiple-screen interactivity between at least a first screen on a first device and a second screen on a second device. The method includes providing complementary content for display on the second screen relative to primary content displayed on the first screen. The method further includes communicating the complementary content to the second device to display on the second screen thereof.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles can be better understood in accordance with the following exemplary figures, in which:

FIG. 1 is a block diagram showing an exemplary two-screen interactivity screen architecture 100, in accordance with an embodiment of the present principles;

FIG. 2 is a flow diagram showing an exemplary method 200 for multiple-screen interactivity, in accordance with an embodiment of the present principles; and

FIG. 3 is a flow diagram showing an exemplary method 300 for providing complementary content, in accordance with an embodiment of the present principles.

### DETAILED DESCRIPTION

The present principles are directed to a multiple-screen interactive screen architecture.

As noted above, most media consumption operations are performed with only one device. For example, a user watching a television program typically will view other television programs on the same viewing device (i.e., the same television). Advantageously, the present principles provide a way of providing complementary content for a user, on a second device. For example, in one or more embodiments, the present principles apply different variations and use cases to an environment where a user has access to a television and a computer (or other device) and, hence, “two-screens”. The idea being that what occurs on the television screen will impact the content shown on the computer display. Likewise, a user's operation of a computer can impact the media shown on the television screen. More examples are explained herein below in accordance with various embodiments of the present principles.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

As noted above, the present principles are directed to multiple-screen interactive screen architecture. Advantageously, depending on the particular implementation, the present principles assist in building a user profile with respect to content of interest to a user, improve a user's experience with respect to media consumption as related items (content, information) can be shown in a secondary device with respect to a primary device, and/or generate revenue from impulse purchases. While primarily described with respect to two screens corresponding to two respective devices, the present principles can be applied to scenarios involving more than two screens.

The present principles are directed to an environment where a user has access to several devices at the same time. For example, consider the environment of a primary device such as a set top box connected to a television and a second device such as a computer or a mobile phone.

Several differing situations can be (some exemplary ones of which are described herein after, although one of ordinary skill in this and related arts will contemplate these and various other situations to which the present principles can be applied while maintaining the scope of the present principles) where what is done on a primary device can be reflected on what is consumed on a second device. In an example below, a cricket match being watched on the primary device can have cricket statistics accessible on a second device. Alternatively, one could present another situation where the secondary device will display a webpage relating to cricket in some way.

The type of media presented for “complementary media” can range from something that is highly interactive (a video game or active social networking application such as chat) to content that is much more passive (a scrolling marquee of statistics or a table of scores). One approach relating to complementary content will provide a user with the ability to select “how interactive” they want the complementary content to be.

As used herein, the phrase “complementary content” refers to content that compliments and/or otherwise relates to primary content corresponding to a primary device. For example, in the case of a football game on television (which can be considered to relate to primary content displayed on a primary device), complementary content can be player statistics, and so forth related to the football game.

Generally, one can provide different types of content on a secondary device such as a program guide information or targeted advertisements which match either the profile of a user and/or the content of what is currently being accessed on the primary device. It is to be appreciated that the primary device and/or the secondary device can be limited to primarily audio with any screen thereon being limited to supporting the reproduced audio (menus, etc.). Thus, in one embodiment, the primary device can be a radio with complementary web information provided on a computer monitor as a secondary device. In another embodiment, the primary device can be a television with the complementary content being audio content provided on a radio. These and other implementations of the present principles are readily determined by one of ordinary skill in this and related arts given the teachings of the present principles provided herein.

Various approaches for how to implement the present principles can consider one or more of the following exemplary factors:
i. The platforms used between devices;
ii. The type of content accessed one each respective device;
iii. The building of profiles for each device;
iv. Does each device operate in view of a managed network or is operation open to the world (e.g., the Internet);
v. Content Protection Issues/Digital Rights Management;
vi. Search/Query/Discovery/Location of Related (e.g., complementary) Information
vii. Content aggregation from different sources—how to collate information; and
viii. Making sure that related content fits together contextually.

It is to be appreciated that the preceding factors are merely illustrative and, thus, other factors can also be used, as readily considered by one of ordinary skill in this and related arts given the teachings of the present principles provided herein.

Moreover, it is to be further appreciated that several different approaches can be taken for the selection of complementary content that is presented to a user. Some exemplary approaches will now be given, although it is to be appreciated that the present principles are not limited to solely the described approaches and, thus, other approaches relating to the selection of complementary content that is present to a user can also be used, as readily considered by one of ordinary skill in this and related arts given the teachings of the present principles provided herein.

In an embodiment, one or more techniques can be used to provide a user with some measure of control over the content on the second screen. For example, the second screen could present the user with a list of thumbnails and allow a user to click through to the item that most interests the user. Moreover, a user can be allowed to control how active or passive the second screen is. For example, in an embodiment, the second screen can be configured to show the best related image. In another embodiment, the second screen can be configured to show a group of thumbnails and allow the user to click through to any particular thumbnail of interest.

In a generalized web search approach, one can submit keywords developed related to content being consumed on a primary device to a search engine. The results from the search engine are presented on the second device. In a prepackaged complementary content approach, controlled content can be delivered where the type of content presented is controlled by the network operator or by other sources (e.g., a service that delivers advertisements based on the content being accessed). Prepackaged content is typically controlled by an entity other than the user and, thus, the user can be limited in terms of the options provided to them. A semi-automatic complementary content approach can combine prepackaged complementary content with dynamic content from approved sources. This approach includes decision making on selecting approved source for content. Ideally, in one or more embodiments, such decisions can be made by a network operator. However, in other embodiments, such decisions can be made by the user themselves.

Additionally, one can insert tags and/or other types of markers into the primary content to assist with this approach and/or provide context extraction techniques (e.g., read closed captioning information, electronic program guide information) to determine attributes about content being accessed. These developed approaches can be used to develop a profile for a user which is kept within a provider's network. That is, a profile for a user can be linked to a particular network provider or content provider such that any device that the user uses for the network will have their profile affecting what is shown on the respective device.

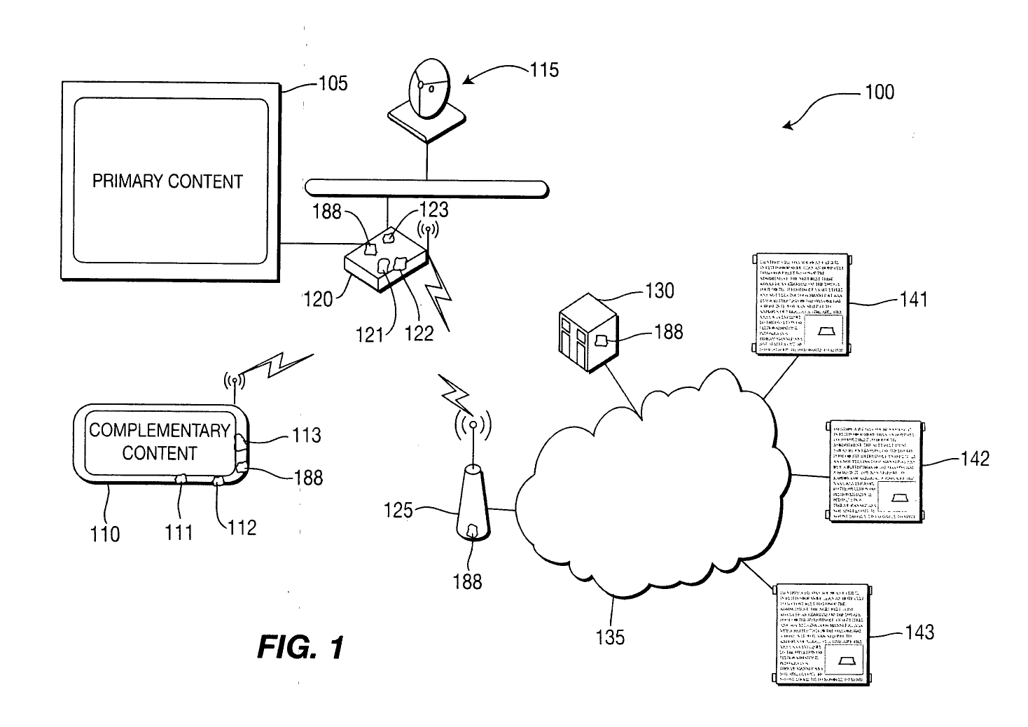

FIG. 1 shows an exemplary two-screen interactivity screen architecture 100, in accordance with an embodiment of the present principles. The architecture 100 can include and/or otherwise involve a primary screen device 105 (e.g., a television), a secondary screen device 110 (e.g., a tablet), a cable/satellite feed 115, a set top box 120 (e.g., a hybrid set top box, etc.), a home gateway 125, an interactivity server 130, a wide area Ian such as the Internet 135, and web services 141, 142, and 143 and the like. The secondary screen device 110 can be, for example, a computer, a tablet, a laptop, a cell phone, a personal digital assistant, a mobile game, and so forth. Thus, it is to be appreciated that while the primary device is shown as a television and the secondary device is shown as a tablet, such devices are not limited to the same, and are capable of being any device that can render information.

It is to be appreciated that the elements and arrangements thereof shown in FIG. 1 are merely illustrative for use in illustrating one or more inventive concepts of the present principles and, thus, other elements and arrangements can also be used, as readily considered by one of ordinary skill in this and related arts given the teachings of the present principles provided herein.

In the scenario depicted in FIG. 1, the primary screen device 105 displays thereon what can be considered as “primary content,” while the secondary screen device 110 displays thereon what can be considered as “complementary content.” The primary screen device 105 is connected to the set top box 120 that is connected to a cable/satellite feed 115 and also to the home gateway 125 via a wireless and/or wired network (not explicitly enumerated). A user navigates content via the secondary screen device 110 that is capable of communicating with both the set top box 120 and the home gateway 125. In an embodiment, the home gateway 125 has storage capabilities and acts as a central media hub to distribute content via the Internet 135. The interactivity server 130 can be controlled by the service provider and provides the context sensitive supplementary information to the secondary screen device 110 in synchronization with the program being watched on the primary screen device 105. The functions performed by the interactivity server 130 can be integrated within the network 135 (e.g., as an enterprise server, etc.), the home gateway 125, a separate element (e.g., computer, etc.) from those shown in FIG. 1, and so forth. A cable television service and a satellite television service are provided herein as examples of content subscription services. Of course, the present principles can be applied to other specific examples and types of content subscription services including, but not limited to, streaming services and web-based services.

The set top box 120 can include a Web engine 121, a media communicator 122 and a caption/electronic program guide (EPG) information (hereinafter caption extractor 123). The second screen device 110 can include a Web browser III, a personalization device/module 112, and a dynamically adaptable user interface 113.

The dynamically adaptable user interface 113 can dynamically adapt at least one of the complementary content and available options capable of being applied to the complementary content based upon at least one of: one or more features of the complementary content; one or more features of the primary content; one or more user preferences; and one or more user inputs, as further described herein by way of one or more examples.

Each of at least the secondary screen device 110 (e.g., the user interface 113 therein), the set top box 120, the interactivity server 130, and the home gateway 125 can be considered to include a filter 188 for filtering content. For example, such filter can filter primary content in order to determine or derive complementary content there from.

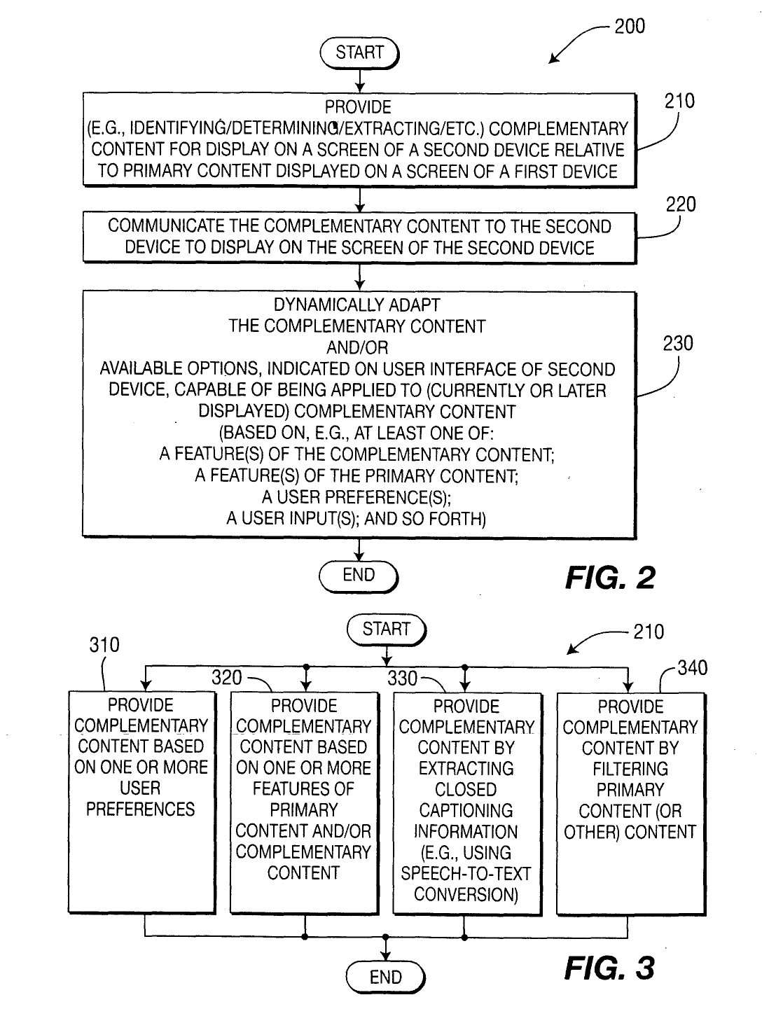

FIG. 2 shows an exemplary method 200 for multiple-screen interactivity, in accordance with an embodiment of the present principles. At step 210, complementary content is provided (e.g., identified, determined, extracted, and so forth) for display on a screen of a second device relative to primary content displayed on a screen of a first device. At step 220, the complementary content is communicated to the second device in order to display the complementary content on the screen of the second device. At step 230, the complementary content and/or available options, indicated on a user interface 113 of the second device, capable of being applied to (currently or later displayed) complementary content, is dynamically adapted based on, for example, at least one of: a feature(s) of the complementary content; a feature(s) of the primary content; a user preference(s); a user input(s); and so forth.

FIG. 3 shows an exemplary method 300 for providing complementary content, in accordance with an embodiment of the present principles. In an embodiment, method 300 further illustrates step 210 of the method 200 of FIG. 2. At step 310, complementary content is provided based on one or more user preferences. At step 320, complementary content is provided based on one or more features of the primary content and/or the complementary content (itself). At step 330, complementary content is provided by extracting closed captioning information (for example, using speech-to-text conversion or via simple extraction of keywords, etc.). At step 340, complementary content is provided by filtering the primary or other content. It is to be appreciated that method 300 can involve one or more of steps 310, 320, 330, and 340, as well as other steps described herein or readily contemplated by one of ordinary skill in this and related arts given the teachings of the present principles provided herein.

The set top box 120 can be a hybrid set top box that is Internet enabled in addition to having access to traditional cable/satellite network feeds (such as, e.g., cable/satellite feed 115). The set top box 120 can include one or more of the following, which can be implemented as software, hardware, or a combination thereof. A web engine that can include a web browser 121 and affiliated encoders and decoders to support various video and audio encoders and decoders (such as, e.g., but not limited to, the International Organization for Standardization/International Electrotechnical Commission (ISO/IEC) Moving Picture Experts Group-2 (MPEG-2) Standard, the (ISO/IEC) MPEG-4 Part 10 Advanced Video Coding (AVC) Standard/International Telecommunication Union, Telecommunication Sector (ITU-T) H.264 Recommendation (hereinafter “H.264”), scalable video coding (SVC), and so forth for video, and Advanced Audio Coding (AAC) and so forth for audio). The set top box 120 can also run a web server on which the entire user interface will be presented to the user. The use of web technologies makes the interface easily customizable and accessible across multiple devices (PCs, TVs).

It can also include a media communicator 122 which can communicate with the home gateway 125 as well as the secondary screen device 110 (e.g., a tablet) and can be responsible for the transfer media from the home gateway 125 to the set top box 120 and can also incorporate functions for the discovery of the home gateway 125 and content on the home gateway 125. In an embodiment, for the discovery mechanism, universal plug and play (UPnP) can be used, and it found unsuitable for some purposes, extensions can be utilized. In an embodiment, hypertext transfer protocol (HTTP), real time streaming protocol (RTSP), and/or so forth can be used for media transfer allowing easy access across devices including laptops/PCs.

The set top box 120 can also include a caption extractor 123. For live content, the caption extractor 123 can extract closed captioning information in real time and stream it to the secondary screen device 110. In an embodiment relating to the case where closed captions are not available, an off-the-shelf speech-to-text software can be used to extract captions. These captions can be used by the personalization engine on the secondary screen device to present context sensitive complementary information to the user.

The secondary screen device 110 acts as a secondary display and provides interactivity to the user. The secondary screen device 110 can be, for example, an Internet tablet, a laptop, a mobile telephone, a media player, a personal digital assistant, and/or so forth. The secondary screen device 110 can include one or more of the following, which can be implemented as software, hardware, or a combination thereof. The web browser 111 can have support for several video, audio and voice encoders and decoders (for example, but not limited to, MPEG-2, H.264, SVC, and so forth for video, and AAC and so forth for audio). In an embodiment, open source browsers with fast javascript execution can be utilized (including, but not limited to, e.g., Firefox, Opera, and so forth). Closed source browsers can also be used. The secondary screen device 110 can also include a personalization device/module 112. The personalization device/module 112 is responsible for providing personalized information (e.g., electronic program guide (EPG), recommended programs, and/or so forth) as well as complementary information to the user. Examples of complementary information can include sports statistics and related news amongst others. As is evident to one of ordinary skill in this and related arts, complementary information is dependent upon the particular implementation of the present principles. For example, for a user viewing sports content such complementary information can similarly involve sports (or not), while for movie content such complementary information can relate to the movie with respect to, for example, songs and/or characters that are part of the same. These and other examples of complementary information are readily determined by one of ordinary skill in this and related arts given the teachings of the present principles provided herein.

The complementary information is in “sync” with the main program on the TV. In an embodiment, social features like the user's presence information and the ability to enter a virtual voice chat with friends who are watching the same program can also be enabled by the personalization module. The personalization module can use the profile information generated by the monitoring module for showing personalized content to the user. While described with respect to the secondary screen device 110, the personalization device/module 112 can also be incorporated in the secondary screen device and/or the primary screen device and/or a communication device such as the set top box 120 and/or the home gateway 125.

The interactivity server 130 is a backend responsible for managing complementary content that is presented to a user on a secondary screen device and is in sync with what the user is watching on a primary screen device (e.g., television). In an embodiment, the interactivity server 130 can allow content creators to specify the approved sources for complementary information (e.g., including, but not limited to, Internet movie database (IMDB), WIKIPEDIA, and so forth) as well as rules on which information cannot be displayed on the secondary screen (for example, competitor's products). In an embodiment, the interactivity server 130 can also serve packaged information that complements the main program and an HTTP based protocol to deliver the content to the secondary screen.

Various examples using the present principles are described below. These scenarios utilize interactive television applications, essentially a blend of the Internet and television. Typical interactive television applications tend to refer to the internet and television as two separate, unconnected experiences. A user can request Internet information or TV information, but the Internet and television are not connected in any meaningful fashion. The present principles provide additional value by coupling the Internet and television viewing experience. Additionally, typical interactive television applications focus on bringing the Internet to the television (the primary screen device). The present principles can provide greater utility by allowing the secondary screen device and the primary screen device to influence each other, providing a connected two screen experience. These examples are centered around the STB/Gateway. The set top box 120 can have a live feed (e.g., cable) and/or an Internet feed as network side inputs. The set top box 120 can be connected to devices in the home through A/V cables (such as, e.g., high definition multimedia interface (HDMI)) and Internet Protocol (IP) (Ethernet and/or wireless).

The home gateway 125 can have a powerful processor. These examples can generally be realized by executing a standard “widget engine” on the home gateway 125 plus one or more of the following. New widgets, new software modules (which connects to the widget), interfaces to set top box software to get/set the current channel (and preferably the channel guide) and/or a web server to export information to secondary screens and the like.

It is to be appreciated that the term “widgets” can be interchangeably referred to herein as “user interface” or “user interface element.” It is to be further appreciated that a widget engine can be located within the communication device (e.g., STB) or another device. For example, if the primary screen device 105 is widget enabled, then the interactivity server 130 can serve the widgets directly to the primary screen device 105.

By utilizing the present principles, the following usage examples can be achieved:

### Secondary Screen Driven by Primary/Secondary Screen Functionalities

A user is watching a television and surfing on his laptop. The user directs their browser to a uniform resource location (URL) such as, for example, http://thomsongateway/2ndscreen and is presented with a web page with content relevant to the current program on television (similar to the current channel widget). As the channel is changed on the television, the secondary screen device (laptop) is updated to reflect the current channel. The user changes the channel to “HANNAH MONTANA” on the DISNEY channel. The secondary screen device is then populated with information about the HANNAH MONTANA movie, and the user looks for show times at his local theaters. The laptop screen is (more or less) continuously updated with information in response to what is currently on the main screen (i.e., television). In an embodiment, voice recognition can be used to help select the content on the secondary screen.

### Current Channel Widget (Primary Screen) TV and Internet Connected

A user is watching the Red Sox/Yankee game. The user presses the widget button on the remote to bring up the widget gallery. The “current channel” widget shows the icons of major league baseball (MLB), the Red Sox and the Yankees. The user selects this widget and a javascript application is displayed with current information on the game including pitcher, catcher, statistics, box score, and so forth. The information that is presented on the “current channel” widget depends on the channel being currently viewed. In addition, it is possible to extract information from the closed captions and episode summaries (in the television guide) to help acquire relevant content. The relevant information for various program types can include, but is not limited to:
(a) sitcom: episode summary;
(b) movie: actors, director, reviews, related content (similar to what would be on the extras of the DVD);
(c) news: news ticker;
(d) stocks: stock news, news ticker;
(e) music video: song purchase info, concert tickets;
(f) soap: actor information, plot backstory;
(g) reality: contestant information;
(h) game show: interactive game;
(i) sports: statistics, box scores;
(j) all: product placement;
(k) all: related images;
(l) all: recommendations;
(m) all: related audio/video (A/V) content;
(n) all: past episodes (catch up television, Hulu, video on demand (VoD)); and
(o) all: Wikipedia info.

In an embodiment, a listener (e.g., including, but not limited to, a speech-to-text or audio watermarking algorithm) can be used to extract extra information.

Selecting Correct Widget/Webpage based on Previous User Selection

A user has a new STB that enables the use of Widgets. The user is watching a baseball match and navigates their laptop to, for example, http://thomsongateway/widgets. The user is presented with the entire list of available widgets. The user wants to pre-filter the list and selects “Related to current program.” With a mouse, the user selects a Widget that provides the user with general sports related results and news. The user wants to use this Widget whenever they are watching a sports program. The user selects “use this widget for the current genre” option. The user also wants to see baseball related information. The user picks the official MLB Widget and selects the “Use this widget for the current program” option. The system knows from the electronic program guide that the user is watching a baseball game and can connect the MLB Widget to this type of sport. The user the switches the channel to a soccer match. The system knows this is still a sports channel. While the MLB widget disappears, the Widget with the sports news and results remains active. The user selects a new Widget from the MLS and ties it to the current program. The user can now see additional information related to the current game in their new widget. While the user is watching the soccer match, the user gets information about the ongoing baseball match from their sports widget. After the soccer match is over, the user switches back to baseball. The MLS widget disappears and the MLB widget becomes active again.

The user can now see the replay of the best scenes in his MLB widget while watching the expert analysis. The user then switches to HBO and both the MLB and the sports widget disappear. The HBO widget, that the user has setup to be used with this channel, automatically pops up. After finishing the movie, the user switches to CNN to watch the latest news. No widget has been setup for this channel or genre. No widget is visible now. On their laptop, the user starts looking for some new interesting widgets. In an embodiment, a user can select on which screen the Widget should be rendered. If the secondary screen is not available, then widgets are rendered on the primary screen. In an embodiment, pre-filtering can be an option set on a per channel basis. In an embodiment, widgets can be pinned at a particular portion of the primary and/or secondary screens.

### Embedded Graphics Removal

A user is watching the baseball game and has their laptop handy. The user navigates the laptop to, for example, http://thomsongateway/2ndscreen and selects “Current Program Info” to receive metadata about the baseball game. However, now that the user has all the metadata available for the current game on their laptop, the embedded graphics on the TV are redundant. Therefore, the user selects a “Remove TV Graphics” option, and the gateway begins receiving a clean television feed with no graphics (or a feed that can be superimposed to remove graphics on the primary screen).

### Other Examples

A widget can also be selected and/or suggested based on an artificial intelligence (AI) scheme and/or business logic and the like. This can be accomplished, for example, when a user has not selected a widget for a channel/program/genre. A set top box (STB) can be utilized to offer an appropriate choice. Widgets can also automatically change when one show ends and another show begins. A user can also move widgets between primary and secondary screen devices.

In another embodiment, a user is watching their home team play a soccer game on a high definition (HD) television (primary screen). There is a player substitution in the game and the user sees a new player being brought on the field. Having never seen this player before, the user wishes to know more about the player, e.g., which team he played for before, how much did his club pay for the trade, how did he perform in the previous season, and so forth. The user pauses their live television feed and uses their gyroscope equipped remote to point to the player in question. This information (e.g., time code inside the stream, x,y location within the frame) is used by a set top box 120 to overlay relevant player statistics acquired from the web onto the television screen.

In yet another embodiment, the user wants the information displayed on their smart phone (secondary screen). The user uses their remote to capture a screen shot of the video frame and sends it over to their secondary screen. The user then uses the touch screen feature of his secondary screen to select the player. Related information is now presented privately on the secondary screen without distracting anyone who also happens to be watching the game along with the user on the primary screen.

These and other features and advantages of the present principles can be readily ascertained by one of ordinary skill in the pertinent art based on the teachings herein. It is to be understood that the teachings of the present principles can be implemented in various forms of hardware, software, firmware, special purpose processors, or combinations thereof.

Most preferably, the teachings of the present principles are implemented as a combination of hardware and software. Moreover, the software can be implemented as an application program tangibly embodied on a program storage unit. The application program can be uploaded to, and executed by, a machine comprising any suitable architecture.

Preferably, the machine is implemented on a computer platform having hardware such as one or more central processing units (“CPU”), a random access memory (“RAM”), and input/output (“I/O”) interfaces. The computer platform can also include an operating system and microinstruction code. The various processes and functions described herein ca-n be either part of the microinstruction code or part of the application program, or any combination thereof, which can be executed by a CPU. In addition, various other peripheral units can be connected to the computer platform such as an additional data storage unit and a printing unit.

It is to be further understood that, because some of the constituent system components and methods depicted in the accompanying drawings are preferably implemented in software, the actual connections between the system components or the process function blocks can differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications can be effected therein by one of ordinary skill in the pertinent art without departing from the scope or spirit of the present principles. All such changes and modifications are intended to be included within the scope of the present principles as set forth in the appended claims.

1. A system for supporting multiple-screen interactivity between at least a first screen on a first device and a second screen on a second device, the system comprising:
an interactivity server that provides complementary content for display on the second screen relative to primary content displayed on the first screen; and
a communication device that communicates the complementary content to the second device to display on the second screen thereof.

2. The system of claim 1, wherein said communication device comprises a set top box having access to multiple content subscription services.

3. The system of claim 2, wherein said set top box comprises a caption extractor for extracting closed captioning information from at least one of the multiple content subscription services and communicating the extracted closed captioning information to the second device for display on the second screen as the complementary content.

4. The system of claim 3, wherein said caption extractor comprises a speech-to-text converter for extracting the closed captioning information from the at least one of the multiple content subscription services.

5. The system of claim 2, wherein the multiple content subscription services comprises at least two of a cable television subscription service, a satellite television subscription service, a streaming content subscription service, and a web-based content subscription service.

6. The system of claim 1, wherein said communication device comprises a gateway device.

7. The system of claim 1, further comprising a personalization device for receiving and managing user preferences, and wherein the complementary content is determined, at least in part, based on the user preferences.

8. The system of claim 1, wherein the first device and the second device comprise at least two of a television, a mobile telephone, a media player, a personal digital assistant, and an Internet tablet, having at least one screen incorporated therein.

9. The system of claim 1, wherein said second device comprises a dynamically adaptable user interface that dynamically adapts at least one of the complementary content and available options capable of being applied to the complementary content based upon at least one of one or more features of the complementary content, one or more features of the primary content, one or more user preferences, and one or more user inputs.

10. The system of claim 1, further comprising a filter for filtering the primary content, and wherein the filtered primary content is displayed on the second display as the complementary content.

11. The system of claim 1, wherein said filter is comprised in at least one of said interactivity server, said communication device, and the second device.

12. The system of claim 1, wherein the primary content relates to a sport game, and the complementary content relates to statistics of at least one of a player, a game, a season, a team, and an event.

13. The system of claim 2, wherein said set top box comprises an electronic program guide information extractor for extracting electronic program guide information from at least one of the multiple content subscription services and communicating the extracted electronic program guide information to the second device for display on the second screen as the complementary content.

14. The system of claim 2, wherein said set top box comprises an electronic program guide information extractor for extracting electronic program guide information from at least one of the multiple content subscription services, polling an Internet service using the extracted electronic program guide information to identify at least a portion of the complementary content, and communicating the portion of the complementary content to the second device for display on the second screen.

15. A method for supporting multiple-screen interactivity between at least a first screen on a first device and a second screen on a second device, the method comprising the steps of:
providing complementary content for display on the second screen relative to primary content displayed on the first screen; and
communicating the complementary content to the second device to display on the second screen thereof.

16. The method of claim 15 further comprising the step of:
obtaining, from at least one of multiple content subscription services, at least one of the primary content and the complementary content.

17. The method of claim 15 further comprising the steps of:
extracting closed captioning information from at least one of the multiple content subscription services; and
communicating the extracted closed captioning information to the second device for display on the second screen as the complementary content.

18. The method of claim 17 further comprising the step of:
utilizing speech-to-text conversion to extract the closed captioning information from the at least one of the multiple content subscription services.

19. The method of claim 16, wherein the multiple content subscription services comprise at least two of a cable television subscription service, a satellite television subscription service, a streaming content subscription service, and a web-based content subscription service.

20. The method of claim 15 further comprising the step of:
dynamically adjusting at least one of the complementary content and available options capable of being applied to the complementary content based upon at least one of one or more features of the complementary content, one or more features of the primary content, one or more user preferences, and one or more user inputs.

21. The method of claim 15 further comprising the step of
receiving and managing user preferences, and wherein the complementary content is determined, at least in part, based on the user preferences.

22. The method of claim 15 further comprising the step of:
filtering the primary content, and wherein the filtered primary is displayed as the complementary content.

23. The method of claim 16 further comprising the steps of:
extracting electronic program guide information from at least one of the multiple content subscription services; and
communicating the extracted electronic program guide information to the second device for display on the second screen as the complementary content.

24. The method of claim 16 further comprising the steps of:
extracting electronic program guide information from at least one of the multiple content subscription services;
polling an Internet service using the extracted electronic program guide information to identify at least a portion of the complementary content; and
communicating the portion of the complementary content to the second device for display on the second screen.
